(19) United States
(12) Patent Application Publication
(10) Pub. No.: US 2008/0214689 A1
(43) Pub. Date: Sep. 4, 2008

(54) Manufacturing method and foaming manufacturing method of polymethyl methacrylate/silica composite material

(76) Inventors: Cheng-Chien Yang, Longtan Township (TW); Jui-Ming Yeh, Jhongli City (TW); Wen-Yo Chen, Longtan Township (TW); Ching-Lung Lin, Longtan Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/712,971

(22) Filed: Mar. 2, 2007

(51) Int. Cl. C08G 18/08

(52) U.S. Cl. 521/122; 524/588; 524/599

(57) ABSTRACT

A manufacturing method and a foaming manufacturing method of polymethyl methacrylate/silica composite material are disclosed. At first, synthesize silica by a sol-gel process. Then, prepare polymethyl methacrylate/silica composite material by bulk polymerization. At last, prepare polymethyl methacrylate/silica foam nanocomposite material from polymethyl methacrylate/silica composite material by a foaming method.

### BACKGROUND OF THE INVENTION

The present invention relates to a manufacturing method of composite material and the foaming manufacturing method thereof, especially to a manufacturing method of polymethyl methacrylate/silica composite material and a foaming manufacturing method thereof.

Metal, ceramic and polymers are three basic materials. However, physical, chemical and mechanical properties of these materials can't meet users requirements now. Composite material is composed of at least two kinds of basic materials. The whole features of the composite material such as malleability or mechanical strength are over a single kind of material. Surface force of different materials increases with decreasing diameter of particles in dispersed phase. Between 1982 to 1983, a term-“nanomaterial” appears. That means dispersed diameter of materials ranges within nanometers (10⁻⁹ m ). Composite materials made by nano-synthesis have a lot of unique features that lead to a lot of potential on development and applications of electronic components, magnetic components, optical elements and structured materials. Since 1990, research of nanocomposite materials become full of vitality and a lot of results are commercialized in various fields. Thus research in this field is an important course of future development.

The development of organic/inorganic hybrid nanomaterials have been over ten years. Since 1990, TOYOTA Central R&D Labs cooperated with UBE machinery corporation, ltd. to mass-produce Nylon 6/clay Nanocomposites that are firstly applied to automobile industry. Such kind of material has both inorganic properties (thermal resistance, shock resistance and tensile resistance) and organic properties (plasticity, optical transparency, and bend resistance) so that it's a new star in industrial materials. The key technology for preparing nanocomposites includes modification and functionalization of inorganic layer. Due to nano-scale bonds between organic and inorganic materials, the composite material achieves maximum additive effect. Only through technology that modifies inorganic material, functions of organic/inorganic nanocomposites are improved for satisfying requirements of compact design, light weight and broad applications.

Synthesis technology of organic/inorganic composite materials is divided into three groups: a hydrothermal method, an intercalation method and a sol-gel method. These methods are similar to synthesis of inorganic catalysts. For example, synthesis of porous crystalline material (zeolite and molecular sieve) uses organic molecules or ions as templates, or by sol-gel method together with hydrothermal method while synthesis of supported layered derivatives that generate molecular-sieve like structure is by intercalation. Once organic/inorganic nanocomposite materials is successfully synthesized, we expect the following goals can be achieved (1) synthesis of periodical organic/inorganic compounds from nano to micron-scale. (2) after sintering above products, periodic porous materials are obtained. (3) synthesis of homogeneous nanoparticles.

Thus it is an important issue that how to conduct organic polymer into netty inorganic materials so as to make materials have properties of toughness of inorganic glass as well as softness of organic polymer.

### SUMMARY OF THE INVENTION

Therefore it is a primary object of the present invention to provide a manufacturing method and a foaming manufacturing method of polymethyl methacrylate/silica composite material that distribute silica inside polymethyl methacrylate in nano-scale.

It is another object of the present invention to provide a manufacturing method and a foaming manufacturing method of polymethyl methacrylate/silica composite material with lower dielectric constant, higher decomposition temperature, higher glass transition temperature and higher storage modulus caused by introduction of silica.

It is a further object of the present invention to provide a manufacturing method and a foaming manufacturing method of polymethyl methacrylate/silica composite material with lower dielectric constant, lower decomposition temperature, lower glass transition temperature and lower storage modulus due to a lot of air conducted through porous structure of the foam nanocomposite material.

In order to achieve above objects, the present invention provide a manufacturing method and a foaming manufacturing method of polymethyl methacrylate/silica composite material. In the beginning, synthesize silica by a sol-gel process. Then, prepare polymethyl methacrylate/silica composite material by bulk polymerization. Next, prepare polymethyl methacrylate/silica foam nanocomposite material from polymethyl methacrylate/silica composite material by a foaming method.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flow chart showing a manufacturing process of silica of an embodiment according to the present invention;

FIG. 2 is a flow chart showing a manufacturing method of polymethyl methacrylate/silica composite material of an embodiment according to the present invention;

FIG. 3 is a flow chart showing a foaming manufacturing method of polymethyl methacrylate/silica composite material of an embodiment according to the present invention;

FIG. 4 is a flow chart showing how to prevent distortion of polymethyl methacrylate/silica composite material during foaming process;

FIG. 5 is a TEM (Transmitted Electron microscopy) image of polymethyl methacrylate/silica of an embodiment according to the present invention;

FIG. 6 is a curve graph showing dielectric constant of polymethyl methacrylate/silica versus different frequencies;

FIG. 7 is a figure showing Thermal Gravimetric Analysis of polymethyl methacrylate/silica composite material according to the present invention;

FIG. 8 is a figure showing Dynamic mechanical analysis (DMA) of polymethyl methacrylate/silica of an embodiment according to the present invention.

### DETAILED DESCRIPTION OF THE PREFERRED EMBODIMENT

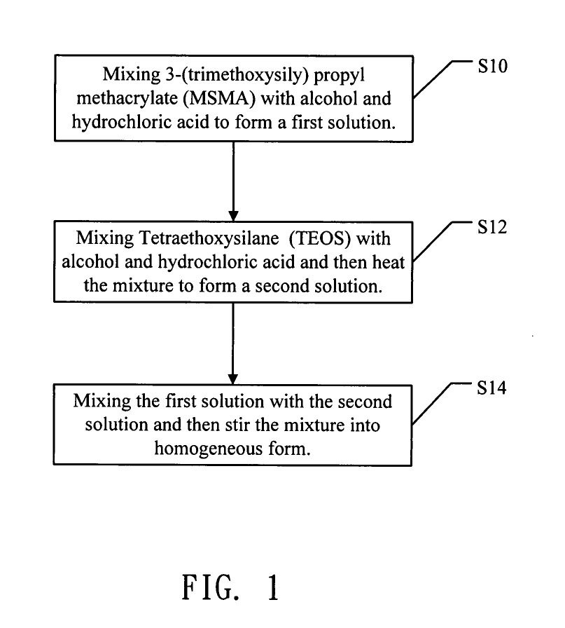

Refer to FIG. 1, a manufacturing flow chart of silica of an embodiment according to the present invention is disclosed. Firstly, as shown in the step S10, mix 3-(trimethoxysily) propyl methacrylate (MSMA) with alcohol and hydrochloric acid to form a first solution. Then refer to the step S12, mix Tetraethoxysilane (TEOS) with alcohol and hydrochloric acid and then heat the mixture to form a second solution. Next the step S14, mix the first solution with the second solution and then stir the mixture into homogeneous form. Then the mixture is grinded into silica powder.

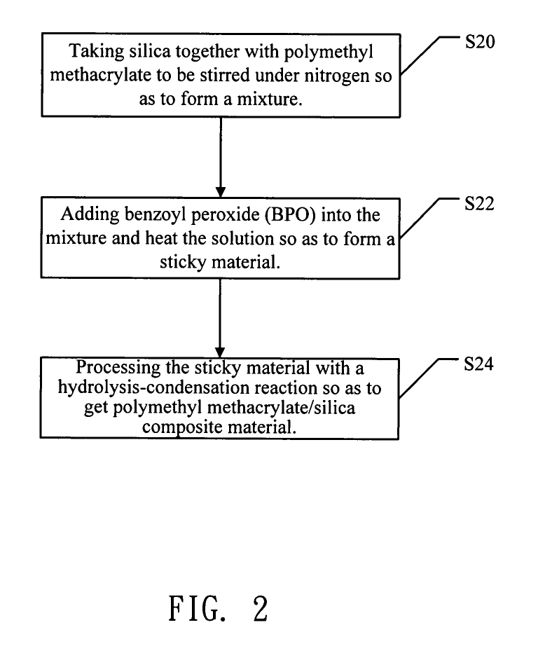

Refer to FIG. 2, a manufacturing flow chart of polymethyl methacrylate/silica composite material of an embodiment according to the present invention is disclosed. Refer to the step S20, take silica together with polymethyl methacrylate to be stirred under nitrogen so as to form a mixture. Then the step S22, add benzoyl peroxide (BPO) into the mixture and heat the solution so as to form a sticky material. Refer to the step S24, process the sticky material with a hydrolysis-condensation reaction so as to get polymethyl methacrylate/silica composite material.

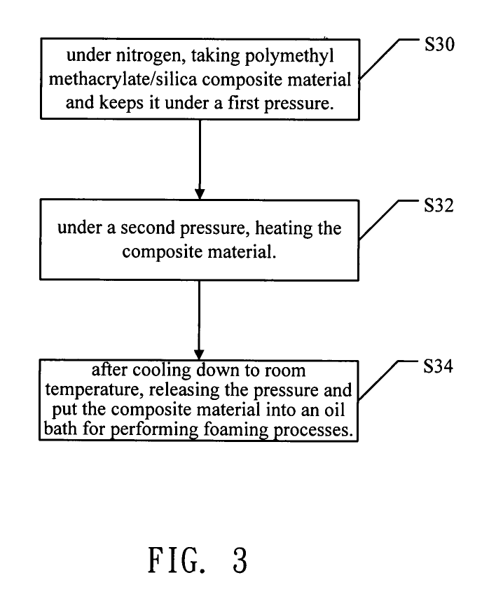

Moreover, refer to FIG. 3, a flow chart of a foaming manufacturing method of polymethyl methacrylate/silica composite material according to the present invention is disclosed. Refer to the step S30, under nitrogen, take polymethyl methacrylate/silica composite material and keeps it under a first pressure. As shown in the step S32, under a second pressure, heat the composite material. Refer to the step S34, after cooling down to room temperature, release the pressure and put the composite material into an oil bath for performing foaming processes.

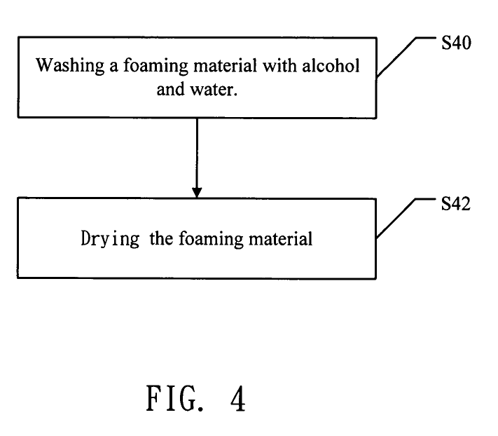

After the step of being put into the oil bath for performing foaming processes, the method further includes a step S40 so as to prevent distortion during foaming process. Refer to FIG. 4, a foaming material is washed with alcohol and water. After being washed into a clean status, take the step S42, the foaming material is dried.

An experiment is taken as an example.

Preparation of silica powder
(1) Preparation of the first solution: take 2.48 g 3-(trimethoxysily)propyl methacrylate (MSMA), 5.0 g alcohol (EtOH) and 0.72 g 1N hydrochloric acid into a 50 ml beaker and then the mixture is stirred by a magnetic bar for a whole day.
(2) Preparation of the second solution: take 18.75 g tetraethoxysilane (TEOS), 10.0 g alcohol (EtOH) and 7.2 g 1N hydrochloric acid into a 250 ml three-neck round bottom flask which is connected with a condenser, a thermometer and a system for nitrogen input and output. Use a magnetic bar to stir the solution and heat the solution into 80 degrees Celsius. Keep the mixture in this temperature until the mixture becoming sticky.
(3) The three-neck round bottom flask with sticky second solution is quickly cooled down to room temperature by ice.
(4) Add the first solution into the cooled second solution and then use a magnetic bar to stir the mixture into homogeneous form.
(5) Pour the mixture into a polypropylene wide-neck plastic bottle to make the solvent volatilize and the residual material contract and crack into clots.
(6) The clots are grinded to get silica powder.

Preparation of polymethyl methacrylate/silica nanocomposite material
(1) Take silica with different weight percent of 0.5%, 1%, 3%, 30.03 g methyl methacrylate monomer into a 250 ml three-neck round bottom flask which is connected with a condenser, a thermometer and a system for nitrogen input and output and the mixture is stirred at the room temperature for an hour.
(2) Add 0.4360 g benzoyl peroxide into the mixture, heat the solution into 85 degrees Celsius and then keep the solution in this temperature until it becomes sticky.
(3) Pour the sticky solution into a glass mold and soak the glass mold into 50 degrees Celsius warm water, keep such status for 24 hours.
(4) Take out the glass mold and soak it into cold water for releasing materials from the mold.
(5) Polymethyl methacrylate/silica composite material is obtained. Preparation of polymethyl methacrylate/silica foam nanocomposite material
(1) Put polymethyl methacrylate/silica nanocomposite material into a high pressure temperature control device.
(2) Fill nitrogen gas unto the device until the pressure up to about 9.75 Mpa, keep the pressure at the room temperature (about 25° C.) for 24 hours.
(3) Start a heater to heat until 150° C. and now the pressure increases into about 13.8 MPa (PV=nRT).
(4) Maintain the material under the condition of about 13.8 Mpa, 150° C. for 5 hours.
(5) Turn off the heater and the temperature is cooled down gradually to room temperature.
(6) Release pressure quicky (in 3 minutes) and put the materials into a pre-heated oil bath at 150° C. for performing foaming processes and the foaming time is set as 5 minutes.
(7) Take the materials out of the oil bath, wash the materials with alcohol and secondary water for multiple times, use detergent to clean oil on surface of materials and pat dry.
(8) Put the dried materials into the oven for vacuum drying for 24 hours at 50° C. so as to get polymethyl methacrylate/silica foam nanocomposite material.

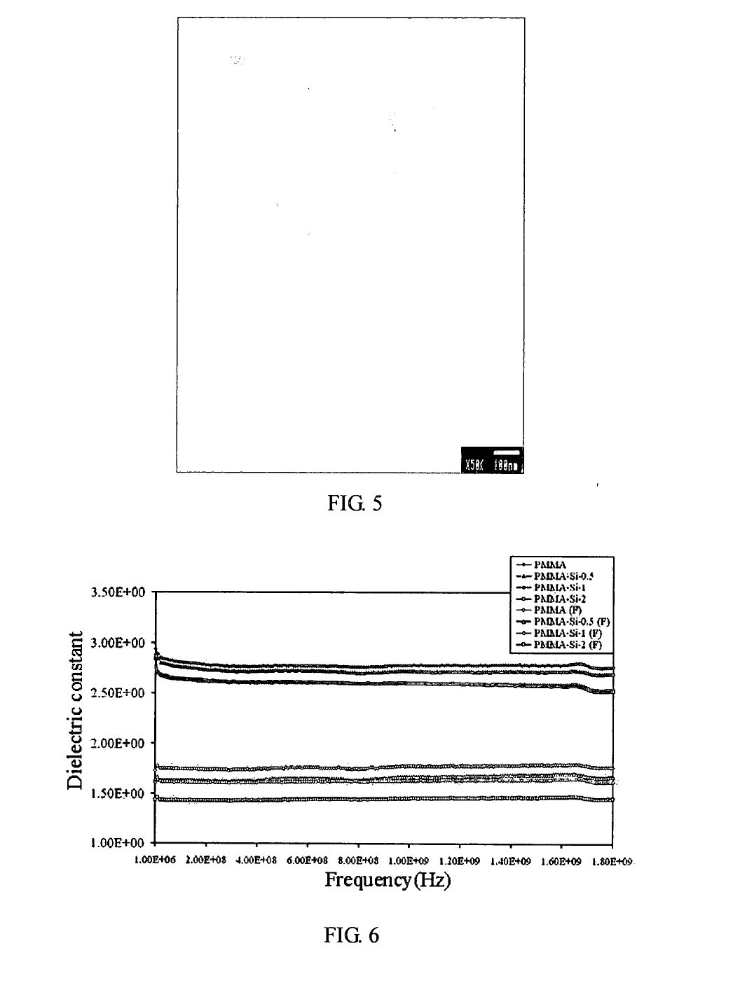

Furthermore, refer to FIG. 5, a TEM (Transmitted Electron microscopy) image of polymethyl methacrylate/silica is disclosed. As shown in figure, a Transmitted Electron microscopy is used to observe distribution of silica inside the polymethyl methacrylate and particle size of the silica. In the figure, the bright area represents polymethyl methacrylate while black spots represent silica. It is learned from the figure that average diameter of silica particles is from 20 nm to 50 nm. Thus inorganic silica is nano-distributed inside the organic polymethyl methacrylate substrate.

In addition, refer to FIG. 6, a curve graph of polymethyl methacrylate/silica according to the present invention shows dielectric constant towards different frequencies. As shown in figure, the dielectric constant of the polymethyl methacrylate/silica nanocomposite material decreases with the increase amount of the silica and increase of the frequency. The reason for this is due to randomly distribution of the silica inside the polymethyl methacrylate/silica nanocomposite material. Such nano-distribution inhibits local re-orientation dynamics of polymers. The silica inhibits dipole orientation inside the polymethyl methacrylate/silica so that such Polarization mechanism has no effect on the dielectric constant. Thus the dielectric constant decreases dramatically. Moreover, dielectric constant of the nanocomposite material after foaming process is fat more lower than the dielectric constant of the nanocomposite material without performing foaming process. This is due to porous structure of the foam nanocomposite material that conducts a lot of air therein.

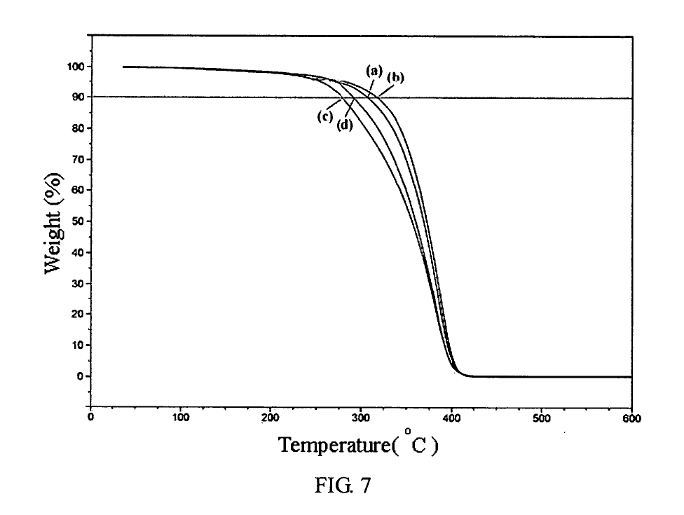

Refer to FIG. 7, a figure shows Thermal Gravimetric Analysis of polymethyl methacrylate/silica according to the present invention. Decomposition temperature increases with increase of the silica amount and it is learned that the silica inside the composite material effectively reduces heat release efficiency and release of flammable gas and further restrict continuous degradation of polymethyl methacrylate. Thus the whole decomposition temperature of the composite material is increased. Therefore, the thermal resistance of the composite material is dramatically improved after the substrate of the polymethyl methacrylate being added with inorganic silica. Furthermore, the thermal stability of the polymethyl methacrylate/silica nanocomposite material before foaming and after foaming can be compared. After being foamed, the whole structure of the material has a lot of pores so that the decomposition temperature of the foaming material decreases.

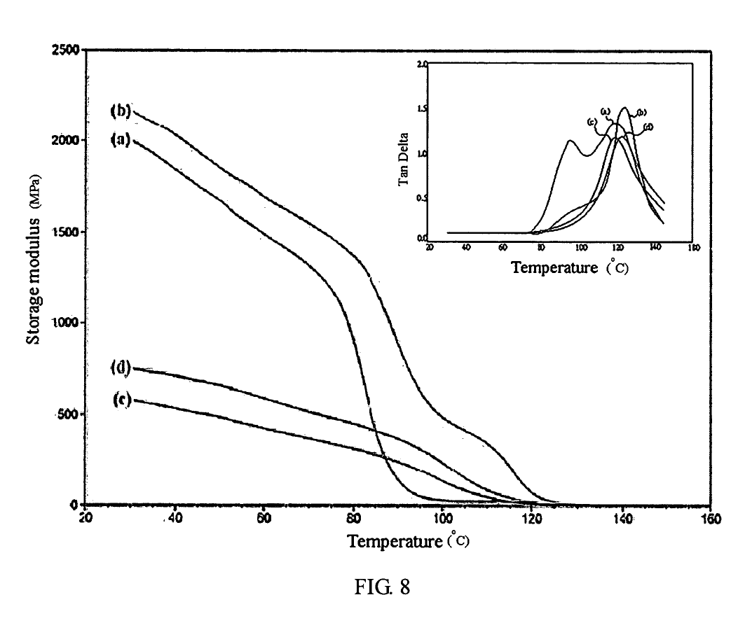

Refer to FIG. 8, a Dynamic mechanical analysis (DMA) of polymethyl methacrylate/silica according to the present invention is disclosed. As shown in figure, along with increase of silica amount, both the storage modulus and glass transition temperature (T_{g}) increase. Thus it is learned that silica nano-distributed inside the composite material effectively restricts molecular mobility among polymer chains so that the molecular chain is difficult to extend or rotate. Thus activity of the molecular chain is reduced. Therefore, mechanical strength and glass transition temperature of the whole material are increased. This effect is getting more obvious when the amount of silica added in increased. Moreover, the mechanical strength and thermal stability of the PMMA/SiO₂_{₂} nanocomposite material before foaming and after foaming can be compared. After being foamed, the whole structure of the foaming material has a lot of pores so that the storage modulus and glass transition temperature (T_{g}) of the foaming material decrease.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A manufacturing method of polymethyl methacrylate/silica composite material comprising the steps of:
mixing silica with polymethyl methacrylate to be stirred under nitrogen so as to form a mixture;
adding benzoyl peroxide (BPO) into the mixture and heat the solution so as to get a sticky material; and
processing the sticky material with a hydrolysis-condensation reaction so as to get polymethyl methacrylate/silica composite material.

2. The method as claimed in claim 1, wherein
mixing 3-(trimethoxysily) propyl methacrylate (MSMA) with alcohol and hydrochloric acid to form a first solution;
mixing Tetraethoxysilane (TEOS) with alcohol and hydrochloric acid and then heat the mixture to form a second solution; and
mixing the first solution with the second solution and then stir the mixture of the first solution and the second solution into homogeneous form.

3. The method as claimed in claim 2, wherein in the step of mixing Tetraethoxysilane (TEOS) with alcohol and hydrochloric acid and then heat the mixture, the heating temperature ranges from 60° C. to 100° C.

4. The method as claimed in claim 2, wherein in the step of mixing the first solution with the second solution, the second solution is cooled down to room temperature in advance.

5. The method as claimed in claim 1, wherein in the step of adding benzoyl peroxide (BPO) into the mixture and heat the solution, the heating temperature ranges from 60 degrees Celsius to 100 degrees Celsius.

6. The method as claimed in claim 1, wherein in the step of processing the sticky material with a hydrolysis-condensation reaction, a way of performing hydrolysis-condensation reaction is to soak the sticky material into water while water temperature ranges from 30 degrees Celsius to 70 degrees Celsius.

7. A foaming manufacturing method of polymethyl methacrylate/silica composite material comprising the steps of:
taking polymethyl methacrylate/silica composite material under nitrogen and keeps the polymethyl methacrylate/silica composite material under a first pressure;
heating the polymethyl methacrylate/silica composite material under a second pressure; and
releasing pressure after the polymethyl methacrylate/silica composite material being cooled down to room temperature and putting the polymethyl methacrylate/silica composite material into an oil bath for performing foaming processes.

8. The method as claimed in claim 7, wherein the first pressure is from 8 Mpa to 11 Mpa.

9. The method as claimed in claim 7, wherein the second pressure is from 13 Mpa to 15 Mpa.

10. The method as claimed in claim 7, wherein time of releasing pressure ranges from 2 to 4 minutes.

11. The method as claimed in claim 7, wherein in the step of heating the polymethyl methacrylate/silica composite material under a second pressure, heating temperature ranges from 140 degrees Celsius to 160 degrees Celsius.

12. The method as claimed in claim 7, wherein after the step of putting the polymethyl methacrylate/silica composite material into an oil bath for performing foaming processes, the method further comprising steps of:
washing a foaming material of polymethyl methacrylate/silica composite material with alcohol and water for multiple times, and drying the foaming material.
